(19) United States
(12) Patent Application Publication
(10) Pub. No.: US 2018/0339407 A1
(43) Pub. Date: Nov. 29, 2018

(54) PNEUMATIC TOOL

(71) Applicant: Basso Industry Corp., Taichung (TW)

(72) Inventors: San-Yih Su, Taichung (TW); Chun-Chi Lai, Taichung (TW)

(73) Assignee: Basso Industry Corp., Taichung (TW)

(21) Appl. No.: 15/983,354

(22) Filed: May 18, 2018

(30) Foreign Application Priority Data
May 25, 2017 (TW) 106207493

(51) Int. Cl. B25F 5/02

(52) U.S. Cl. CPC B25F 5/02; B25B 21/00

(57) ABSTRACT

A pneumatic tool includes a main body unit, a switch unit and a trigger unit. The main body unit defines a flow path, and an annular space surrounding the flow path. The flow path includes a front path section, and a rear path section separated from the front path section. The switch unit includes a sleeve member movable relative to the main body unit between an opening position where fluid communication between the front path section and the rear path section is permitted, and a closing position where fluid communication between the front path section and the sear path section is prevented. The trigger unit is rotatably mounted to the main body unit, and includes a trigger member operable to move the sleeve member between the opening position and the closing position.

### CROSS-REFERENCE TO RELATED APPLICATION

This application claims priority of Taiwanese Invention Patent Application No. 106207493, filed on May 25, 2017.

### FIELD

The disclosure relates to a pneumatic tool, and more particularly to a pneumatic tool having a trigger unit.

### BACKGROUND

Referring to FIGS. 1 and 2, Taiwanese Utility Model Patent No. M444900 discloses a conventional pneumatic tool including a first part 11 that has two connecting grooves 111, a second part 12 that has two connecting holes 121, two connecting members 13 each of which is removably inserted into a respective one of the connecting grooves 111 and a respective one of the connecting holes 121 for separably interconnecting the first and second parts 11, 12, a valve rod 14 that is movably mounted to the first part 11 for guiding inflow of air, a trigger member 15 that is mounted to the first part 11 and that is movable to switch the valve rod 14, and a tool head 16 that is mounted to the second part 12 for outputting power. By removing the connecting members 13, the first and second parts 11, 12 are rotatable relative to each other so as to adjust the relative position between the tool head 16 and the trigger member 15.

Since the first and second parts 11, 12 are separable, a pressure drop may easily occur when a gap between the first and second parts 11, 12 is not air-tightly sealed. The operation to rotate the first and second parts 11, 12 relative to each other is inconvenient.

### SUMMARY

Therefore, an object of the disclosure is to provide a pneumatic tool that can alleviate at least one of the drawbacks of the prior art.

According to the disclosure, the pneumatic tool includes a main body unit, a switch unit and a trigger unit. The main body unit defines a flow path that extends from a rear side toward a front side for guiding air to flow thereinto, and an annular space that surrounds the flow path. The flow path includes a front path section that is proximate to the front side, and a rear path section that is proximate to the rear side and that is separated from the front path section. The switch unit includes a sleeve member that is movably mounted to the annular space of the main body unit. The sleeve member is movable relative to the main body unit between an opening position where fluid communication between the front path section and the rear path section is permitted, and a closing position where fluid communication between the front path section and the rear path section is prevented. The trigger unit is rotatably mounted to the main body unit, and includes a trigger member. The trigger member abuts against the sleeve member, and is operable to move the sleeve member between the opening position and the closing position.

### BRIEF DESCRIPTION OF THE DRAWINGS

Other features and advantages of the disclosure will become apparent in the following detailed description of the embodiments with reference to the accompanying drawings, of which:

FIG. 1 is a sectional view illustrating a conventional pneumatic tool;

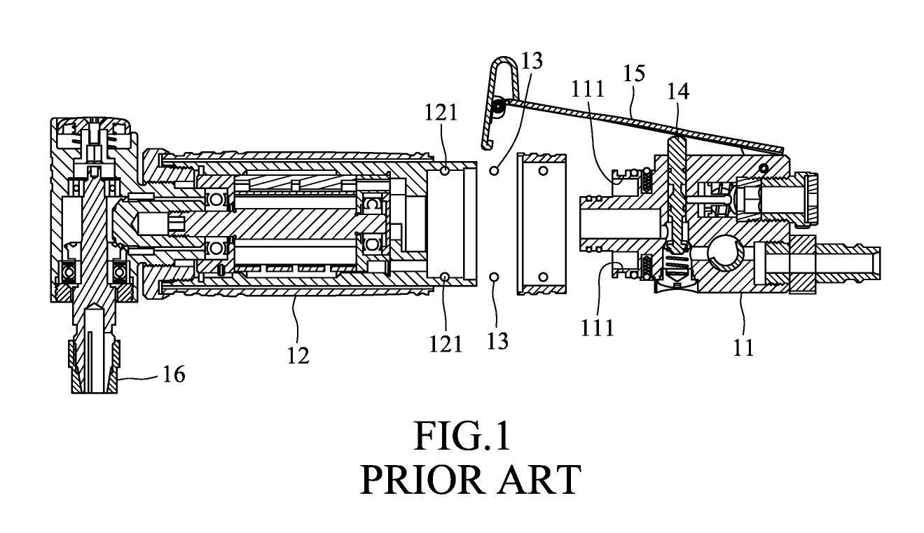

FIG. 2 is a schematic perspective view illustrating the conventional pneumatic tool;

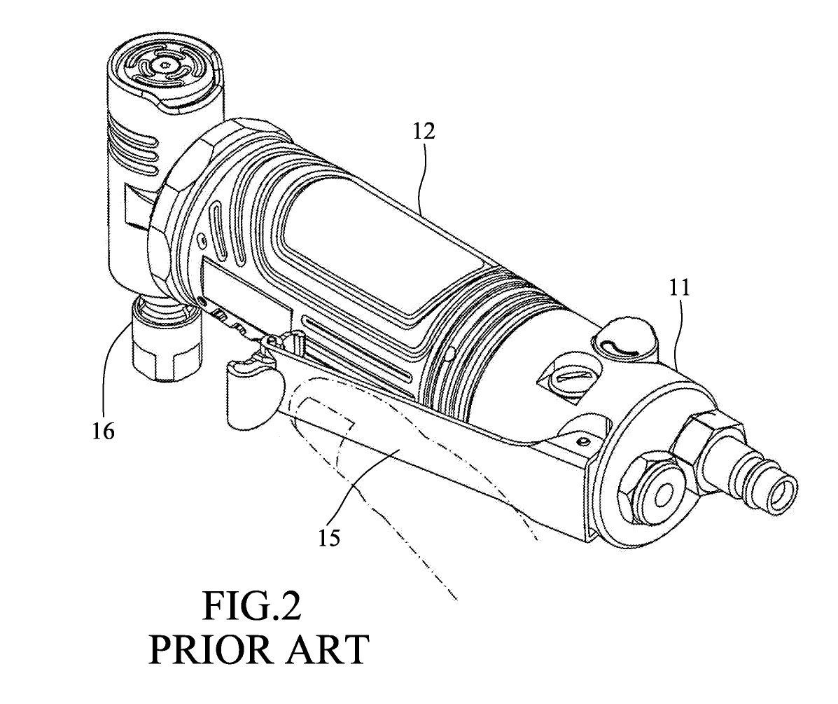

FIG. 3 is an exploded perspective view illustrating a first embodiment of the pneumatic tool according to the disclosure;

FIG. 4 is a side view illustrating the first embodiment;

FIG. 5 is a fragmentary sectional view illustrating a sleeve member of the first embodiment at a closing position;

FIG. 6 is a fragmentary sectional view illustrating the sleeve member at an opening position;

FIG. 7 is a fragmentary sectional view illustrating a sleeve member of a second embodiment of the pneumatic tool according to the disclosure at a closing position; and

FIG. 8 is a fragmentary sectional view illustrating the sleeve member at an opening position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

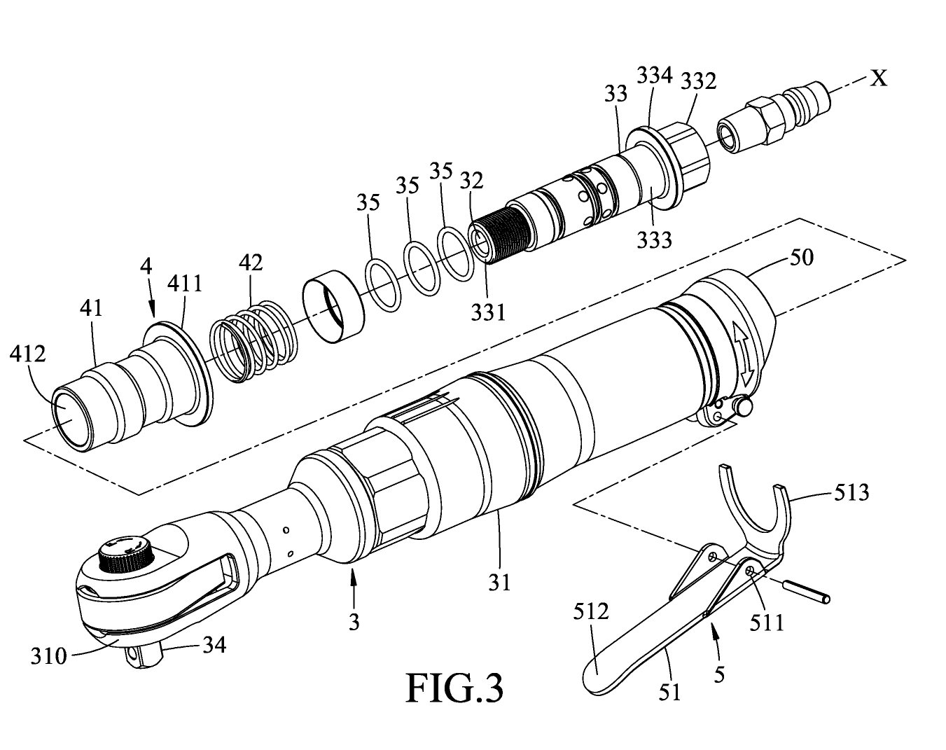

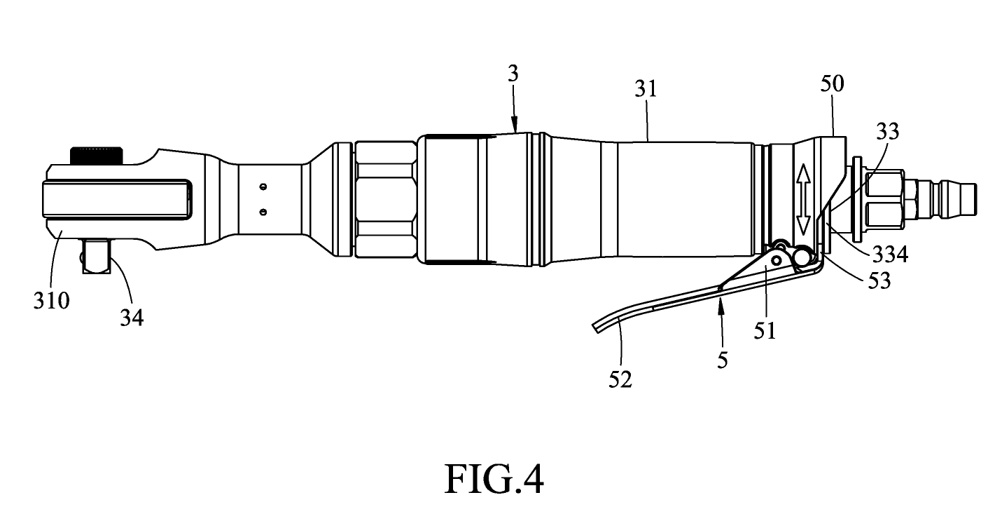

Referring to FIGS. 3 to 6, the first embodiment of the pneumatic tool according to the disclosure includes a main body unit 3, a switch unit 4 and a trigger unit 5.

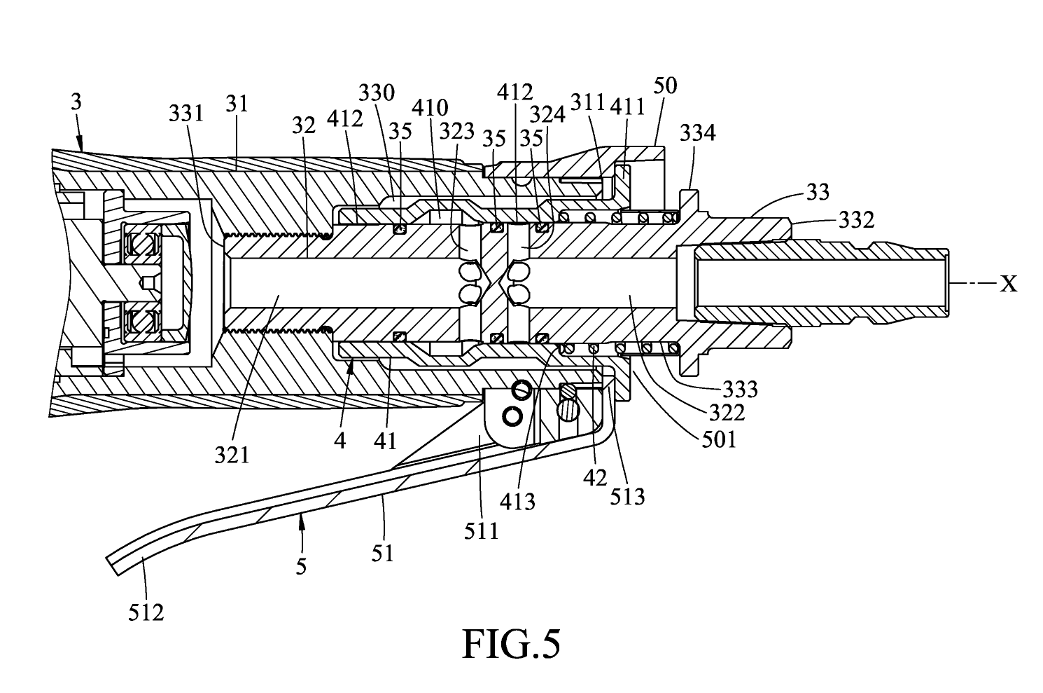

The main body unit 3 includes a hollow main body 31 that has a front end portion 310 and a rear end portion 311 (see FIG. 5), a tubular member 33 that surrounds an axis (X) to define a flow path 32 and that is surrounded by the main body 31, a tool head 34 that is mounted to the front end portion 310 of the main body 31 for outputting power, and three air-tight members 35 that are disposed on an outer surface 333 of the tubular member 33. The tubular member 33 cooperates with the main body 31 to define an annular space 330 therebetween (the annular space 330 surrounds the flow path 32), and has a front portion 331 that is inserted into the main body 31, a rear portion 332 that is disposed out of the main body 31, and a stop flange 334 that is proximate to the rear portion 332. The flow path 32 extends from the rear portion 322 toward the front portion 311 for guiding air to flow into the main body 31, and includes a front path section 321 that is proximate to the front end portion 310 of the main body 31, a rear path section 322 that is proximate to the rear end portion 311 of the main body 31 and that is separated from the front path section 321, a front tributary section 323 that is formed through the outer surface 333 of the tubular member 33 and that communicates the front path section 321 with the annular space 330, and a rear tributary section 324 that is formed through the outer surface 333 of the tubular member 33 and that communicates the rear path section 322 with the annular space 330. The front path section 321 and the rear path section 322 are not in direct fluid communication with each other. The air-tight members 35 are spaced apart from each other along the axis (X). The front one of the air-tight member 35 is located at a front side of the front tributary section 323 distal from the rear tributary section 324, the middle one of the air-tight members 35 is located between the front tributary section 323 and the rear tributary section 324, and the rear one of the air-tight members 35 is located at a rear side of the rear tributary section 324 distal from the front tributary section 323. In one embodiment, each of the air-tight members 35 is sleeved on the tubular member 33. In one embodiment, the flow path 32 may include a plurality of front tributary sections 323 each of which extends in a direction perpendicular to the axis (X), and a plurality of rear tributary sections 324 each of which extends in a direction perpendicular to the axis (X).

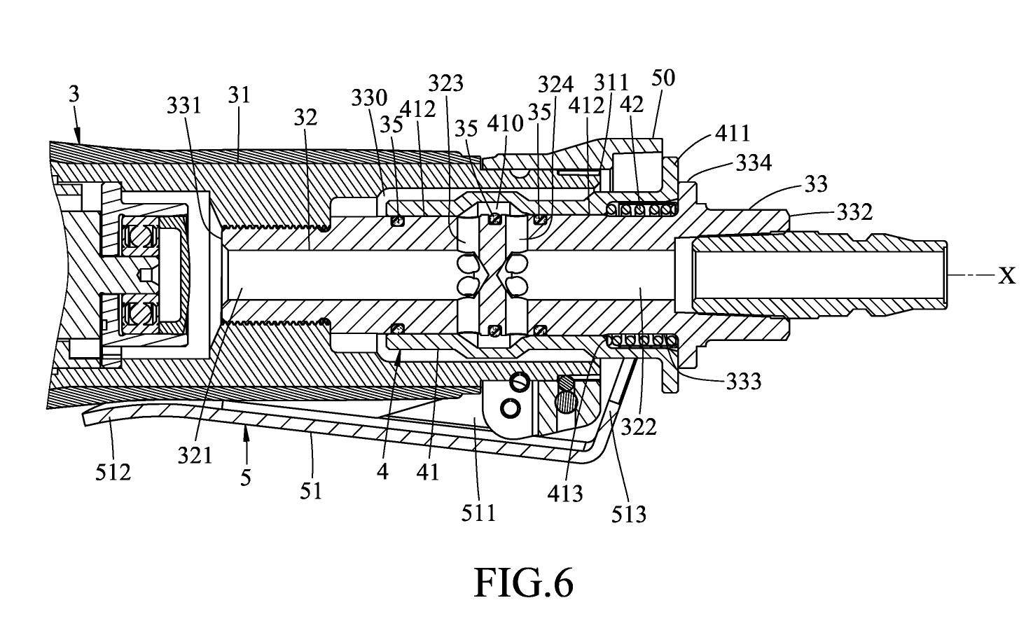

The switch unit 4 includes a sleeve member 41 that surrounds the tubular member 33 and that extends into the annular space 330 defined between the tubular member 33 and the main body 31, and a restoring member 42. The sleeve member 41 cooperates with the tubular member 33 to define an annular communication gap 410 therebetween, and has an annular driven portion 411 at a rear end thereof that is disposed out of the main body 31, two inner surface portions 412 that are respectively located at two opposite sides of the communication gap 410 along the axis (X), and a stop surface 413 that faces toward the stop flange 334 of the tubular member 33. Each of the inner surface portions 412 surrounds the axis (X). The sleeve member 41 is movable relative to the tubular member 33 between an opening position (see FIG. 6) where the sleeve member 41 is proximate to the rear portion 332 of the tubular member 33, and a closing position (see FIG. 5) where the sleeve member 41 is distal from the rear portion 332 of the tubular member 33. In one embodiment, the restoring member 42 is configured as a compression spring that has two opposite ends respectively abutting against the stop flange 334 of the tubular member 33 and the stop surface 413 of the sleeve member 41 to resiliently bias the sleeve member 41 toward the closing position. The sleeve member 41 can be positioned at the opening position by the stop flange 334 of the tubular member 33.

When the sleeve member 41 is at the opening position (see FIG. 6), the inner surface portions 412 of the sleeve member 41 are at least partially spaced apart from the middle one of the air-tight members 35, and are respectively in air-tight contact with the front and rear ones of the air-tight members 35, so that the communication gap 410 is in fluid communication with both of the front tributary section 323 and the rear tributary section 324. As such, fluid communication between the front path section 321 and the rear path section 322 via the front tributary section 323, the communication gap 410 and the rear tributary section 324 is permitted. When the sleeve member 41 is at the closing position (see FIG. 5), the inner surface portions 412 of the sleeve member 41 are respectively in air-tight contact with the front and middle ones of the air-tight members 35, so that the communication gap 410 is not in fluid communication with the rear tributary section 324. As such, the fluid communication between the front path section 321 and the rear path section 322 is prevented.

The trigger unit 5 includes an annular mounting seat 50 and a trigger member 51. The mounting seat 50 is rotatably mounted to the main body 31, and is proximate to the rear end portion 311 of the main body 31. The mounting seat 50 surrounds a portion of the sleeve member 41 that is disposed out of the main body 31, and is formed with a breach 501. The trigger 51 has a pivoted portion 511 that is pivoted to the mounting seat 50, and a control portion 512 and a driving portion 513 that are respectively located at two opposite sides of the pivoted portion 511. The driving portion 513 is C-shaped, extends into the breach 501 of the mounting seat 50, and abuts against the driven portion 411 of the sleeve member 41. The control portion 512 is distal from the main body 31 when the sleeve member 41 is at the closing position (see FIG. 5), and is able to be depressed so that the driving portion 513 pushes and moved the sleeve member 41 to the opening position (see FIG. 6).

Referring to FIG. 5, when the control portion 512 of the trigger member 51 is not depressed, the sleeve member 41 is maintained at the closing position by the restoring member 42. At this time, the fluid communication between the front path section 321 and the rear path section 322 is prevented, so compressed air flowing into the rear path section 322 is prevented from flowing into the front path section 321 to actuate the tool head 34.

Referring to FIG. 6, when the control portion 512 of the trigger member 51 is depressed, the driving portion 513 pushes and moved the sleeve member 41 to the opening position against the biasing action of the restoring member 42. At this time, the fluid communication between the front path section 321 and the rear path section 322 via the front tributary section 323, the communication gap 410 and the rear tributary section 324 is permitted, so compressed air flowing into the rear path section 322 is permitted to flow into the front path section 321 to actuate the tool head 34.

It should be noted that the relative angular position between the tool head 34 and the trigger member 51 can be adjusted by rotating the mounting seat 50 relative to the main body 31. Moreover, since the sleeve member 41 has the annular driven portion 411 for being pushed by the driving portion 513 of the trigger member 51, the trigger member 51 is constantly operable to move the sleeve member 41 after the relative angular position between the tool head 34 and the trigger member 51 is arbitrarily adjusted.

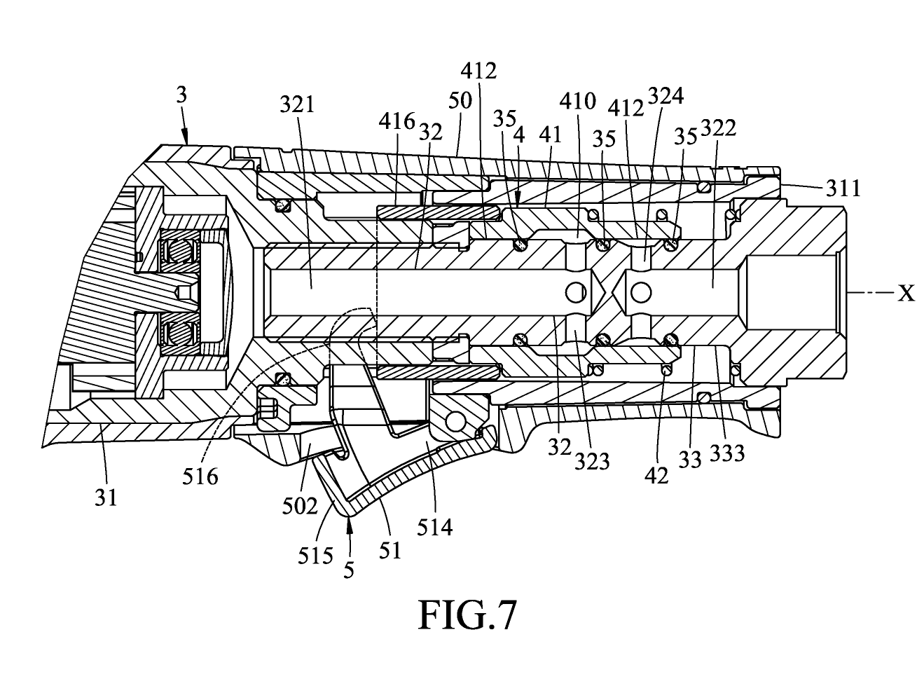

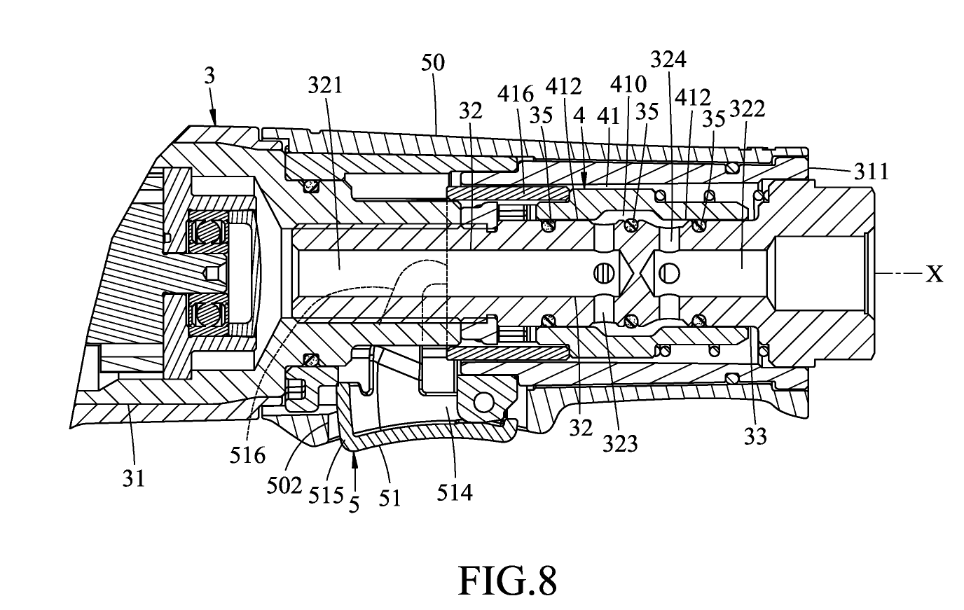

Referring to FIGS. 7 and 8, the second embodiment of the pneumatic tool according to the disclosure is similar to the first embodiment.

The sleeve member 41 has an annular driven portion 416 at the front end thereof that is movably disposed in the annular space 330.

The mounting seat 50 of the trigger unit 5 has a breach 502 formed at a front end thereof. The trigger member 51 has a pivoted portion 514 that is pivoted to the mounting seat 50, and a control portion 515 and a driving portion 516 that are located at the same side of the pivoted portion 514. The driving portion 516 is C-shaped (with reference to the driving portion 513 in FIG. 3), extends into the main body 31 via the breach 502 of the mounting seat 50, and abuts against the driven portion 416 of the sleeve member 41. The control portion 515 is able to be depressed for moving the sleeve member 41 from the closing position (see FIG. 7) to the opening position (see FIG. 8).

Referring to FIG. 7, when the control portion 515 of the trigger member 51 is not depressed, the sleeve member 41 is maintained at the closing position by the restoring member 42. At this time, the inner surface portions 412 of the sleeve member 41 are respectively in air-tight contact with the front and middle ones of the air-tight members 35, so the fluid communication between the front path section 321 and the rear path section 322 is prevented. As a result, the compressed air flowing into the rear path section 322 is prevented from flowing into the front path section 321 to actuate the tool head 34.

Referring to FIG. 8, when the control portion 515 of the trigger member 51 is depressed, the driving portion 516 pushes and moved the sleeve member 41 to the opening position against the biasing action of the restoring member 42. At this time, the inner surface portions 412 of the sleeve member 41 are spaced apart from the middle one of the air-tight members 35, and are respectively in air-tight contact with the front and rear ones of the air-tight members 35, so the fluid communication between the front path section 321 and the rear path section 322 via the front tributary section 323, the communication gap 410 and the rear tributary section 324 is permitted. As a result, the compressed air flowing into the rear path section 322 is permitted to flow into the front path section 321 to actuate the tool head 34.

Similarly, since the sleeve member 41 has the annular driven portion 416 for being pushed by the driving portion 516 of the trigger member 51, the trigger member 51 is constantly operable to move the sleeve member 41 after the relative angular position between the tool head 34 and the trigger member 51 is arbitrarily adjusted.

The advantages of the disclosure are as follows:

1. The sleeve member 41 is mounted in the main body 31, and has the annular driven portion 416 for being pushed by the trigger member 51, so the trigger unit 5 can be easily mounted to the main body without consideration of the relative angular position between the sleeve member 41 and the trigger member 51.

2. The mounting member 50 is rotatably mounted to the main body 31, so the relative angular position between the tool head 34 and the trigger member 51 can be easily adjusted.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A pneumatic tool comprising:
a main body unit defining a flow path that extends from a rear side toward a front side for guiding air to flow thereinto, and an annular space that surrounds said flow path, said flow path including a front path section that is proximate to the front side, and a rear path section that is proximate to the rear side and that is separated from said front path section;
a switch unit including a sleeve member that is movably mounted to said annular space of said main body unit, said sleeve member being movable relative to said main body unit between an opening position where fluid communication between said front path section and said rear path section is permitted, and a closing position where fluid communication between said front path section and said rear path section is prevented; and
a trigger unit rotatably mounted to said main body unit, and including a trigger member, said trigger member abutting against said sleeve member, and being operable to move said sleeve member between the opening position and the closing position.

2. The pneumatic tool as claimed in claim 1, wherein said main body unit includes a hollow main body, and a tubular member that surrounds an axis to define said flow path and that is surrounded by said main body, said tubular member cooperating with said main body to define said annular space therebetween.

3. The pneumatic tool as claimed in claim 2, wherein said main body unit includes a plurality of air-tight members that are disposed on an outer surface of said tubular member, said flow path further including a front tributary section that communicates said front path section with said annular space, and a rear tributary section that communicates said rear path section with said annular space, at least one of said air-tight members being located at a front side of said front tributary section that is distal from said rear tributary section, at least one of said air-tight members being located between said front tributary section and said rear tributary section, at least one of said air-tight members being located at a rear side of said rear tributary section distal from said front tributary section, when said sleeve member is at the opening position, said sleeve member being at least partially spaced apart from said air-tight member that is located between said front tributary section and said rear tributary section so that said front tributary section and said rear tributary section are in fluid communication with each other, when said sleeve member is at the closing position, said sleeve member being in air-tight contact with said air-tight member that is located between said front tributary section and said rear tributary section so that said front tributary section and said rear tributary section are not in fluid communication with each other.

4. The pneumatic tool as claimed in claim 3, wherein said sleeve member of said switch unit has an inner surface portion that surrounds the axis when said sleeve member is at the opening position, said inner surface portion of said sleeve member being at least partially spaced apart from said air-tight member that is located between said front tributary section and said rear tributary section, when said sleeve member is at the closing position, said inner surface portion of said sleeve member being in air-tight contact with said air-tight member that is located between said front tributary section and said rear tributary section.

5. The pneumatic tool as claimed in claim 4, wherein said sleeve member of said switch unit further has an additional inner surface portion, and cooperates with said tubular member to define an annular communication gap that is located between said inner surface portion and said additional inner surface portion, when said sleeve member is at the opening position, said communication gap being in fluid communication with both of said front tributary section and said rear tributary section so that said front tributary section and said rear tributary section are in fluid communication with each other, when said sleeve member is at the closing position, said communication gap being separated from said rear tributary section so that said front tributary section and said rear tributary section are no in fluid communication with each other.

6. The pneumatic tool as claimed in claim 2, wherein said switch unit further includes a restoring member that has two opposite ends respectively abutting against said tubular member and said sleeve member to resiliently bias said sleeve member toward the closing position.

7. The pneumatic tool as claimed in claim 2, wherein said trigger member has a control portion for being operated, and a driving portion that abuts against said sleeve member and that is operable to push said sleeve member.

8. The pneumatic tool as claimed in claim 7, wherein said tubular member of said main body unit has a stop flange, said sleeve member being able to be positioned at the opening position by said stop flange, said sleeve member having an annular driven portion at a rear end thereof, said control portion and said driving portion being respectively located at two opposite ends of said trigger member, said driving portion abutting against said driven portion of said sleeve member.

9. The pneumatic tool as claimed in claim 7, wherein said sleeve member has an annular driven portion at a front end thereof that is movably disposed in said annular space, said control portion and said driving portion being proximate to each other, said driving portion extending into said main body and abutting against said driven portion of said sleeve member.

10. The pneumatic tool as claimed in claim 7, wherein said trigger unit further includes a mounting seat that is rotatably mounted to said main body unit and is proximate to a rear end of said main body unit, said trigger member further having a pivoted portion that is pivoted to said mounting seat and that is located between said control portion and said driving portion, said control portion being spaced apart from said main body unit when said sleeve member is at the closing position.
